(19) United States
(12) Patent Application Publication
(10) Pub. No.: US 2008/0282722 A1
(43) Pub. Date: Nov. 20, 2008

(54) Methods and Apparatus for Dispensing Beverages

(76) Inventors: Clive Justin Edmonds, Norfolk (GB); Daniel Peterson Godfrey, Cambridge (GB); Lucy Sheldon, Cambridge (GB); Nicholas Martin Broadbent, Cambridge (GB)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/091,256

(22) PCT Filed: Nov. 2, 2006
(86) PCT No.: PCT/GB06/04096

§ 371 Date: Apr. 23, 2008

(30) Foreign Application Priority Data
Nov. 3, 2005 (GB) 0522465.4
May 12, 2006 (GB) 0609505.3

(51) Int. Cl. F25C 1/22; B67D 5/62; C03C 3/32

(52) U.S. Cl. 62/340; 62/66; 65/389; 222/146.5

(57) ABSTRACT

The present invention provides an apparatus for dispensing a beverage, the beverage comprising a liquid-beverage portion and a frozen-beverage portion. The apparatus comprises means for dispensing into a receptacle the liquid beverage portion, means (102) for freezing a portion of beverage so as to provide the frozen beverage portion and means (104, 104′ for dispensing the frozen-beverage portion into the receptacle. The present apparatus also provides a method for dispensing a frozen beverage portion by providing one or more cooling chambers (102) cooled by cooling means, supplying at least one of the cooling chambers with a portion of beverage, freezing the portion of beverage to provide at least one beverage frozen-beverage portion and ejecting one frozen beverage portion from its cooling chamber.

This invention relates to methods and apparatus for dispensing beverages, in particular, draught beverages. Most preferably, the beverages are alcohol-containing beverages, such as cider or beer, in particular.

In a first aspect, the invention provides an apparatus for dispensing a frozen-beverage portion, the apparatus comprising:

means for freezing a portion of beverage, so as to provide a frozen-beverage portion; and

means for dispensing the frozen-beverage portion into a receptacle.

The means for freezing a portion of beverage is preferably one or more cooling chambers cooled by a cooling means. Preferably, the or each chamber is sized so as to be capable of cooling sufficient beverage to form a frozen-beverage portion for only a single dispense i.e. the or each chamber has a volume comparable to the volume of the frozen-beverage portion added to a single receptable e.g. a pint glass. Preferably there is a plurality of cooling chambers. Most preferably, there is a plurality of cooling chambers, each chamber for freezing a portion of beverage to form a frozen-beverage portion sufficient for only a single dispense i.e. for addition to only a single receptable e.g. a pint glass.

The or each chamber has an opening through which the frozen-beverage portion can be ejected. The or each opening may be provided with a sealing member to seal the opening when no dispense is occurring. Biasing means may also be provided to bias the sealing means towards/against the opening.

The or each chamber may be substantially arcuate in shape. The radius of curvature of the chamber may be constant or may vary. Preferably, the radius of curvature of the chamber increases (preferably gradually) towards the opening.

A cross-section through the chamber in a radial direction may be, for example, substantially a circle, substantially a rectangle or substantially an isosceles trapezoid. The area of the cross-section through the chamber in a radial direction may be constant along the arc or, preferably, it may increase (preferably gradually) towards the opening. This facilitates dispense of the frozen-beverage portion.

The inside of the one or more chambers may be coated in a friction-reducing (non-stick) layer such as a fluorocarbon coating layer, for example PTFE to further assist in dispensing the frozen-beverage portion.

Any number of chambers can be provided. In some embodiments, four chambers are provided. In other embodiments six or seven chambers are provided.

The apparatus may further include a flow meter for measuring the amount of beverage supplied to the or each chamber. The flow meter may comprise a magnetic turbine which spins as the portion of beverage for freezing flows over it and a hall-effect sensor which detects the spinning magnetic field and converts it into a digital pulse.

The cooling means may be, for example, a Peltier element connected to a heat sink, a refrigeration system, a flash cooler, a pipe/channel system for carrying coolant (e.g. water and/or glycol) which may be fed from the beverage cooling system or may be fed from a dedicated chiller. Most preferably, the cooling means comprises a pipe/channel system for carrying glycol or glycol/water.

In preferred embodiments, the glycol or glycol/water flow in the cooling means is controllable and can be stopped so that the walls of the cooling chamber increase slowly in temperature (by heat transfer from the surroundings) to avoid the frozen beverage portion from becoming too solid for ejecting.

The means for dispensing the frozen-beverage portion preferably comprises at least one element for mechanically forcing the frozen-beverage from the one or more cooling chambers. The or each element is preferably a plunger or piston which can apply a force to the frozen beverage to push it from the one or more cooling chambers.

In some embodiments, the apparatus may be provided with at least one stop member which can act to limit the movement of the or each element so that only a fraction of the frozen beverage portion is ejected from the one or more cooling chambers. For example, if the or each chamber is sized so that the volume of frozen beverage portion within the chamber is sufficient only for a single pint dispense, the or each stop member may act to allow dispense of only half of the volume of the chamber when a half pint dispense is required.

In some embodiments, a dedicated element is provided for each cooling chamber. In alternative embodiments, a single element is provided which is moveable between a plurality of chambers.

One type of element which may be used is that which forms a movable base of a cooling chamber. The moveable base forms a sealing engagement against the lowermost point of the chamber thus preventing leakage when a portion of beverage for freezing is introduced. To dispense the frozen-beverage portion, the moveable base can be moved towards the opening of the chamber to push the frozen-beverage from the cooling chamber through the opening. Preferably, each of the one or more cooling chambers is provided with such an element.

An alternative element which may be used is a pivoting plunger which is external to the cooling chamber(s) prior to dispensing a frozen-beverage portion and which can pivot to sweep through a cooling chamber towards the opening of the chamber to push the frozen-beverage portion from the cooling chamber. Preferably, a single pivoting plunger is provided, the plunger being moveable between a plurality of chambers.

Additionally, the means for dispensing the frozen-beverage portion may further comprise means for providing reduced-size particles of the frozen-beverage portion.

Preferably, the means for providing reduced-size particles is a sheet having one or more holes, the sheet located adjacent to the opening of the cooling chamber through which the frozen-beverage is forced by the at least one element. The sheet may be, for example, a grill, grate or mesh.

Preferably, the apparatus is for dispensing the frozen-beverage portion and a liquid-beverage portion and further comprises means for dispensing into the receptacle a liquid-beverage portion.

The means for dispensing the liquid-beverage portion into the receptacle is preferably a tap mounted on a bar-top dispense font.

The means for freezing the portion of beverage and the means for dispensing the frozen-beverage portion are preferably housed in a dispense font. Most preferably, they are housed in the dispense font bearing the means for dispensing the liquid-beverage portion (e.g. a tap). The means for dispensing the liquid- and frozen-beverage portions may be located proximally, so that both beverage portions can be dispensed without needing to move the receptacle.

The receptacle may be a measured glass comprising indicia indicative of a desired proportion of the volume of the glass. The desired proportion of liquid volume can be from 50% to 99% and, preferably, from 85% to 95%.

Herein, the term “measured glass” is utilised to indicate that the glass has a known volume. Such glasses are extremely common in public houses, etc., as any pint or half-pint glass, or the like, is a measured glass.

The invention also relates to an apparatus as described herein and/or as shown in the accompanying drawings.

In a second aspect, the invention provides a method for dispensing a frozen-beverage portion, the method comprising:

providing one or more chambers cooled by a cooling means;

supplying at least one of the chambers with a portion of beverage;

freezing the portion of beverage to provide at least one frozen-beverage portion; and

ejecting one of the at least one frozen-beverage portions from its chamber.

Preferably, the or each chamber is sized so as to be capable of cooling a portion of beverage to form a frozen-beverage portion for only a single dispense i.e. the or each chamber has a volume comparable to the volume of the frozen-beverage portion added to a single receptacle e.g. a pint glass. Preferably there is a plurality of cooling chambers. Most preferably, there is a plurality of cooling chambers, each chamber for freezing a portion of beverage to form a frozen-beverage portion sufficient for only a single dispense i.e. for addition to only a single receptacle e.g. pint glass.

The or each chamber has an opening through which the frozen-beverage portion can be ejected. The or each opening may be provided with a sealing member to seal the opening when no dispense is occurring. Biasing means may also be provided to bias the sealing means towards/against the opening.

The or each chamber may be substantially arcuate in shape. The radius of curvature of the chamber may be constant or may vary. Preferably, the radius of curvature of the chamber increases (preferably gradually) towards the opening.

A cross-section through the chamber in a radial direction may be, for example, substantially a circle, substantially a rectangle or substantially an isosceles trapezoid. The area of the cross-section through the chamber in a radial direction may be constant along the arc or, preferably, it may increase (preferably gradually) towards the opening. This facilitates ejection of the frozen-beverage portion.

The inside of the one or more chambers may be coated in a friction-reducing (non-stick) layer, such as a fluorocarbon coating layer, for example, Teflon® to further assist in frozen-beverage ejection.

Any number of chambers can be provided. In some embodiments, four chambers are provided. In other embodiments, six or seven chambers may be provided.

The cooling means may be, for example, a Peltier element connected to a heat sink, a refrigeration system, a coolant (e.g. water and/or glycol) which may be fed from the beverage cooling system or may be fed from a dedicated chiller. Most preferably, the cooling means comprises a pipe/channel system for carrying glycol or glycol/water.

In preferred embodiments, the glycol or glycol/water flow in the cooling means is controllable and can be stopped so that the walls of the cooling chamber increase slowly in temperature (by heat transfer from the surroundings) to avoid the frozen beverage portion from becoming too solid for ejecting.

Preferably, at least one chamber is supplied with the portion of beverage for freezing under the line pressure of the beverage dispense system and/or under the influence of gravity. Preferably, the portion of beverage is supplied so that it runs down the chamber walls to avoid frothing. Preferably, the flow of beverage into the or each chamber is measured using a flow meter comprising a magnetic turbine and a hall-effect sensor.

Ejecting the frozen-beverage portion involves the use of ejection means which, preferably, comprises at least one element for mechanically forcing (pushing) the frozen-beverage from the one or more cooling chambers. The or each element is preferably a plunger or piston which can apply mechanical force the frozen beverage to push it from the one or more cooling chambers.

In some embodiments, the ejecting of the frozen beverage portion may be limited by at least one stop member which can act to limit the movement of the or each element so that only a fraction of the frozen beverage portion is ejected from the one or more cooling chambers. For example, if the or each chamber is sized so that the volume of frozen beverage portion within the chamber is sufficient only for a single pint dispense, the or each stop member may act to allow dispense of only half of the volume of the chamber when a half pint dispense is required.

In some embodiments, a dedicated element is provided for each cooling chamber. In alternative embodiments, a single element is provided which is moveable between a plurality of chambers.

One type of element which may be used is that which forms a movable base of a cooling chamber. The or each moveable base forms a sealing engagement against the lowermost point of its respective chamber thus preventing leakage when a portion of beverage for freezing is introduced. To eject the frozen-beverage portion, the moveable base can be moved towards the opening of the chamber to push the frozen-beverage from the cooling chamber through the opening. Preferably, each cooling chamber is provided with such an element.

An alternative element which may be used is a pivoting plunger which is external to the cooling chamber(s) prior to dispensing a beverage and which can pivot to sweep through a cooling chamber towards the opening of the chamber to push the frozen-beverage portion from the cooling chamber. Preferably, a single pivoting plunger is provided, the plunger being moveable between a plurality of chambers.

Additionally, ejecting the frozen-beverage portion may further comprise reducing the particle size of the frozen-beverage portion. This may be achieved using a sheet having one or more holes, the sheet being located adjacent the opening of the cooling chamber through which the frozen-beverage is forced by the at least one element. The sheet may be, for example, a grill, grate or mesh.

Preferably, the method further comprises providing means for dispensing a liquid-beverage portion and dispensing a liquid-beverage portion. The means for dispensing the liquid-beverage portion is preferably a tap mounted on a bar-top dispense font.

The cooling chamber(s) and ejection means are preferably provided in a dispense font. Most preferably, they are provided in the dispense font bearing the means for dispensing the liquid-beverage portion (e.g. a tap). The means for dispensing the liquid-beverage portion and the ejection means may be provided proximally, so that both beverage portions can be dispensed without needing to move the receptacle.

The liquid-beverage and frozen-beverage portions may be dispensed in any order. For example, the ejected frozen-beverage portion(s) may be dispensed into a receptacle containing a liquid-beverage portion. Dispensing the frozen-beverage portion provides a layer of substantially frozen beverage on top of the previously dispensed liquid beverage, in the form of a beverage head. Alternatively, the frozen-beverage portion is ejected into an empty receptacle and a liquid beverage portion is subsequently added. In this case, the frozen-beverage portion will rise to the top of the receptacle to form a beverage head as the liquid beverage is dispensed. In yet another alternative, the frozen-beverage portion is ejected into a receptacle at substantially the same time as a liquid-beverage portion or the frozen-beverage portion is ejected into a partly dispensed liquid-beverage portion (e.g. 70% of the liquid-beverage portion volume) following which the remaining liquid-beverage portion is dispensed.

Preferably, one or both of the liquid- and/or frozen-beverage portions is an/are alcohol-containing beverage(s). Further preferably, the liquid- and frozen-beverage portions comprise the same beverage, for example, cider or beer.

The liquid- and/or frozen-beverage portion(s) may comprise an alcohol content of from 0.05% to 14% and, preferably, from 2% to 8%.

In another aspect, the invention provides a beverage dispensing system comprising:

one or more fonts for dispensing a liquid-beverage portion and a frozen-beverage portion into a receptacle; and

a supply of beverage to the one or more fonts, the supply of beverage being separatable to provide a liquid-beverage portion and a portion of beverage for freezing to provide a frozen-beverage portion;

wherein, the liquid- and frozen-beverage portions are dispensable into the receptacle.

In a further aspect, the invention provides a method for dispensing a beverage comprising:

dispensing a liquid portion of a water-based beverage into a receptacle; and

dispensing a frozen portion of a water-based beverage into the receptacle.

Preferably, one or both of the liquid- and/or frozen-beverage portions is an/are alcohol-containing beverage(s). Further preferably, the liquid- and frozen-beverage portions comprise the same beverage, for example, cider or beer.

The liquid-beverage and frozen-beverage portions may be dispensed in any order. For example, the ejected frozen-beverage portion(s) may be dispensed into a receptacle containing a liquid-beverage portion. Dispensing the frozen-beverage portion provides a layer of substantially frozen beverage on top of the previously dispensed liquid beverage, in the form of a beverage head. Alternatively, the frozen-beverage portion is ejected into an empty receptacle and a liquid beverage portion is subsequently added. In this case, the frozen-beverage portion will rise to the top of the receptacle to form a beverage head as the liquid beverage is dispensed. In yet another alternative, the frozen-beverage portion is ejected into a receptacle at substantially the same time as a liquid-beverage portion or the frozen-beverage portion is ejected into a partly dispensed liquid-beverage portion (e.g. 70% of the liquid-beverage portion volume) following which the remaining liquid-beverage portion is dispensed.

The liquid- and/or frozen-beverage portion(s) may comprise an alcohol content of from 0.05% to 14% and, preferably, from 2% to 8%.

The frozen-beverage portion is preferably subjected to mechanical forces, so as to provide reduced-size particles of the frozen-beverage portion prior to dispensing into the receptacle.

The term “water-based beverage”, as used herein, is utilised to define a beverage which has a water content but which also includes any number of other ingredients typically provided in beverages. The water-based beverages may include any number of the following ingredients: alcohol; flavourings; sweeteners; preservatives; and/or colourings; for example. Use of the term “ingredients” is not intended to cover minerals and or other impurities naturally present in water.

In a yet further aspect, the invention provides a method for dispensing a beverage comprising:

dispensing a liquid portion of a beverage into a receptacle; and

dispensing a frozen portion of an alcohol-containing beverage into the receptacle.

Preferably, the liquid-beverage portion comprises an alcohol-containing beverage and, further preferably, the liquid-beverage portion and the frozen-beverage portion are the same beverage, for example, cider or beer.

The liquid-beverage and frozen-beverage portions may be dispensed in any order. For example, the ejected frozen-beverage portion(s) may be dispensed into a receptacle containing a liquid-beverage portion. Dispensing the frozen-beverage portion provides a layer of substantially frozen beverage on top of the previously dispensed liquid beverage, in the form of a beverage head. Alternatively, the frozen-beverage portion is ejected into an empty receptacle and a liquid beverage portion is subsequently added. In this case, the frozen-beverage portion will rise to the top of the receptacle to form a beverage head as the liquid beverage is dispensed. In yet another alternative, the frozen-beverage portion is ejected into a receptacle at substantially the same time as a liquid-beverage portion or the frozen-beverage portion is ejected into a partly dispensed liquid-beverage portion (e.g. 70% of the liquid-beverage portion volume) following which the remaining liquid-beverage portion is dispensed.

The liquid- and/or frozen-beverage portion(s) may comprise an alcohol content of from 0.05% to 14% and, preferably, from 2% to 8%.

The frozen-beverage portion is preferably subjected to mechanical forces, so as to provide reduced-size particles of the frozen-beverage portion prior to dispensing into the receptacle.

In order that the invention may be fully disclosed, embodiments will now be described, by way of example only, with reference to the accompanying drawings, in which:

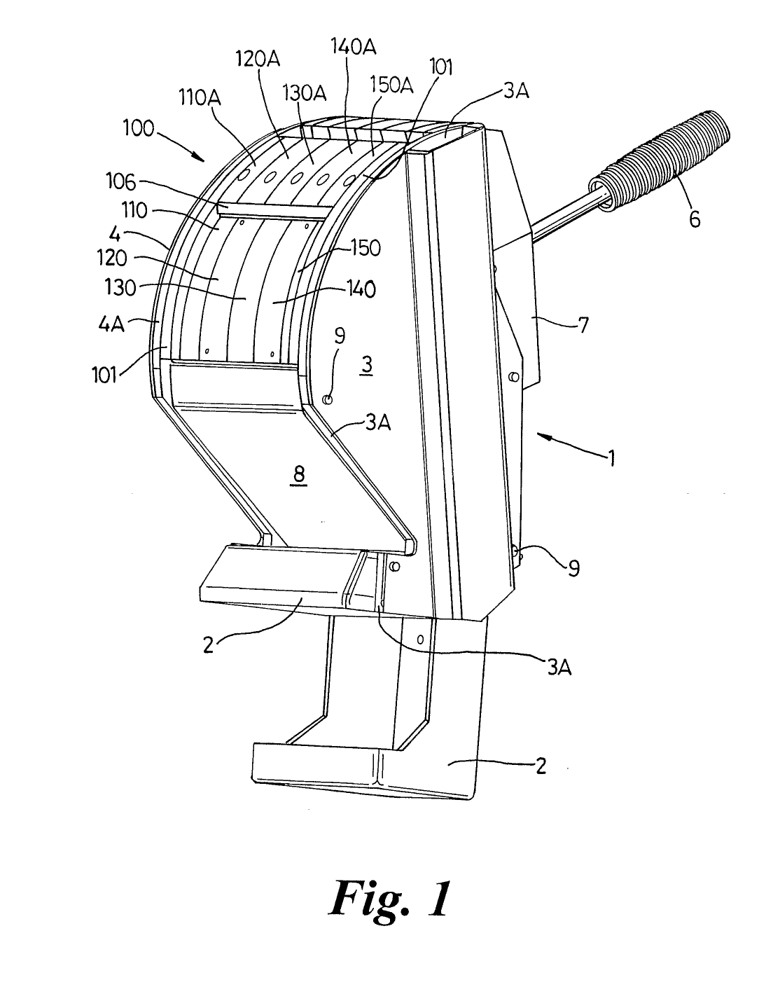

FIG. 1 is a perspective view of a front and right-hand side of a dispensing apparatus according to a first embodiment of the present invention;

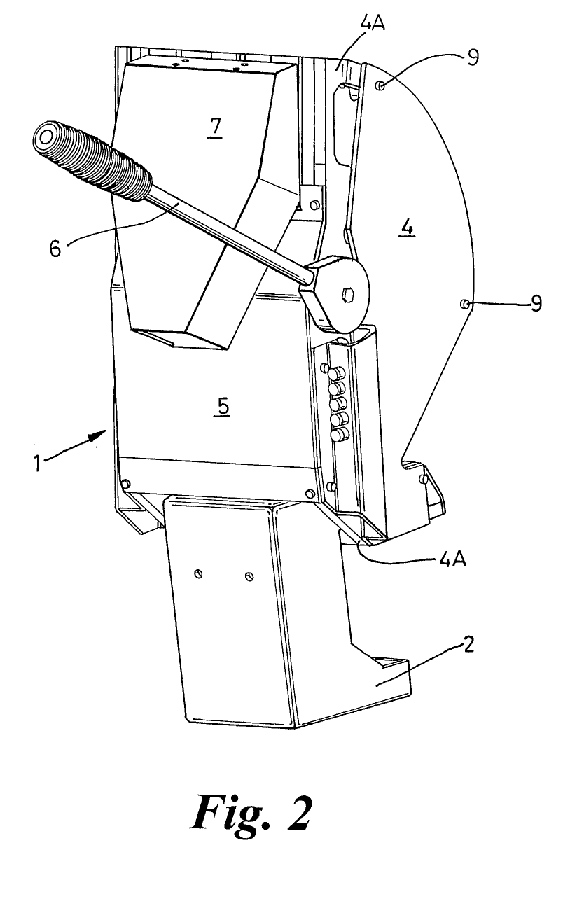

FIG. 2 is a perspective view of a rear and left-hand side of the dispensing apparatus of FIG. 1;

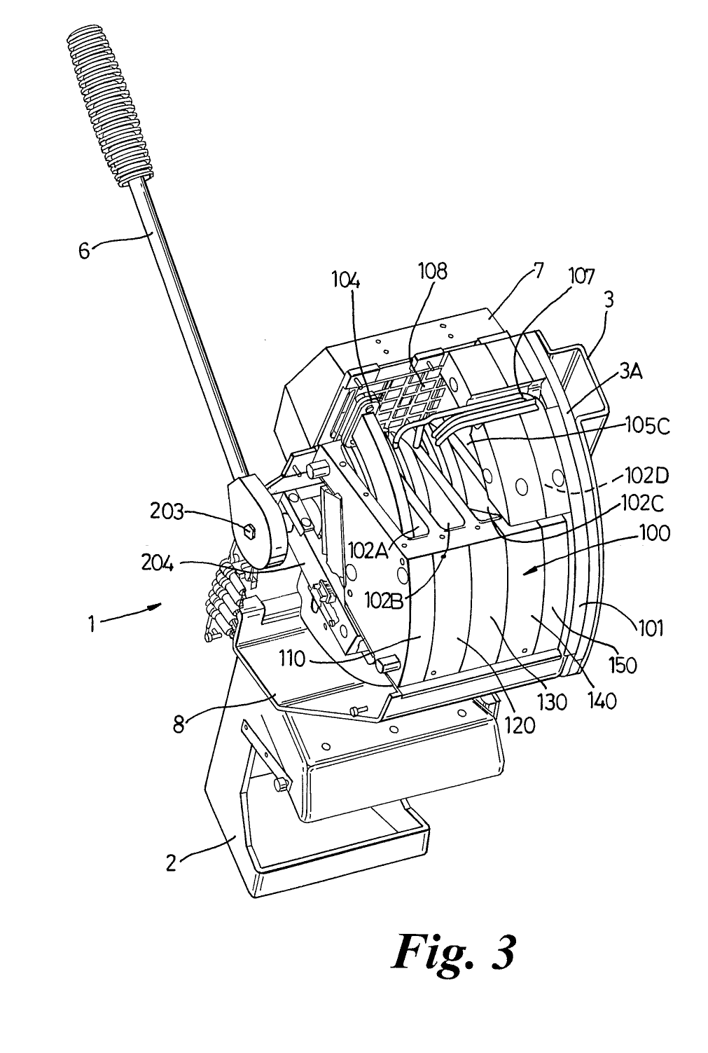

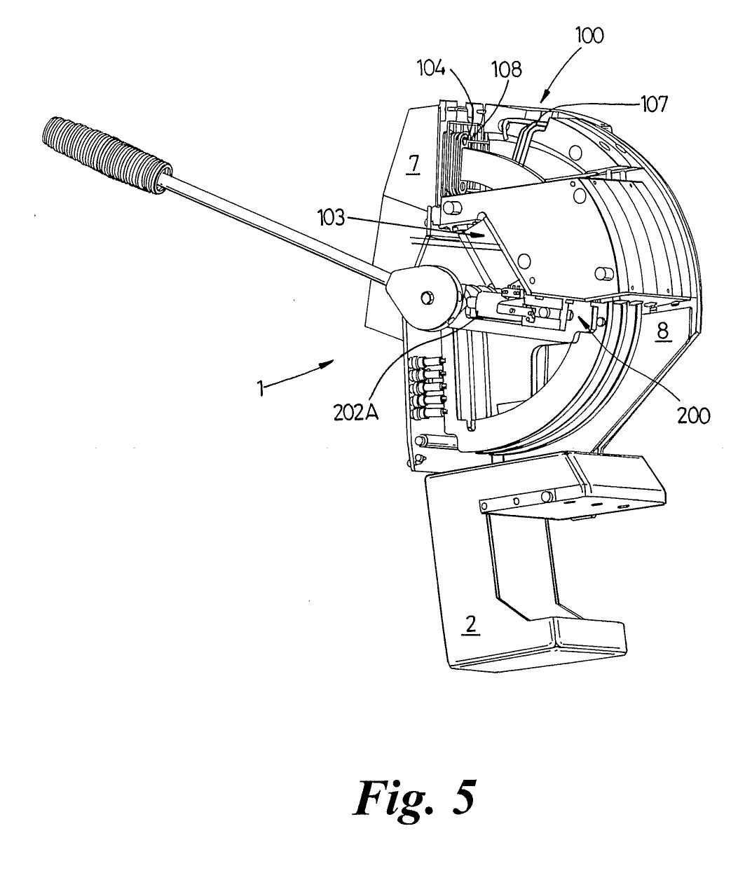

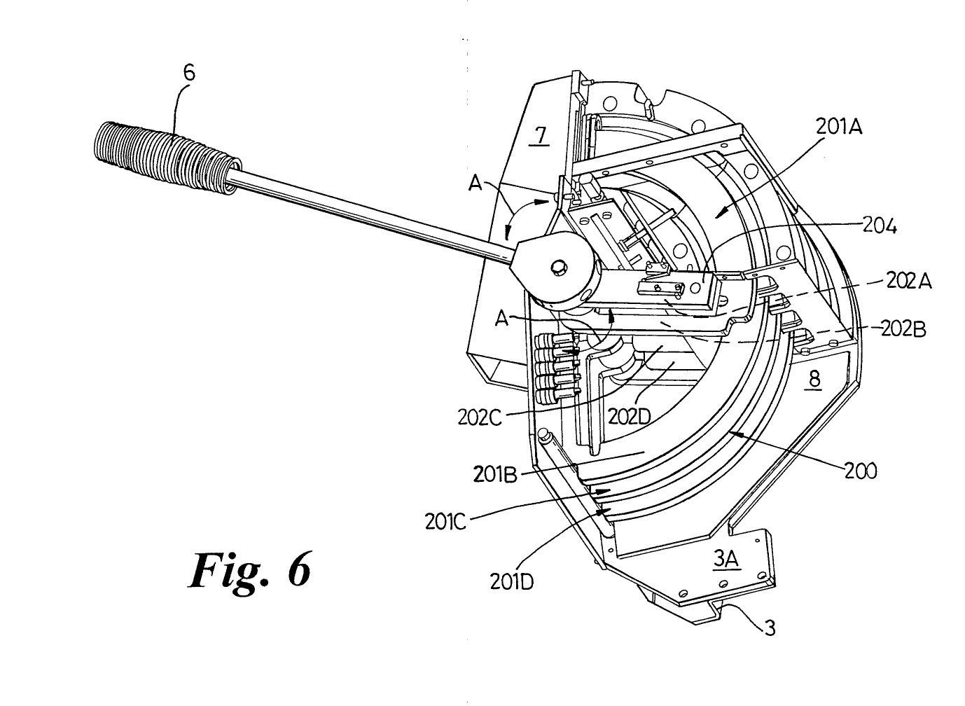

FIGS. 3 to 7 are part-internal views of the dispensing apparatus of FIG. 1 from the left-hand side from which some external parts of the apparatus have been removed and show a plunger in its dispensed position;

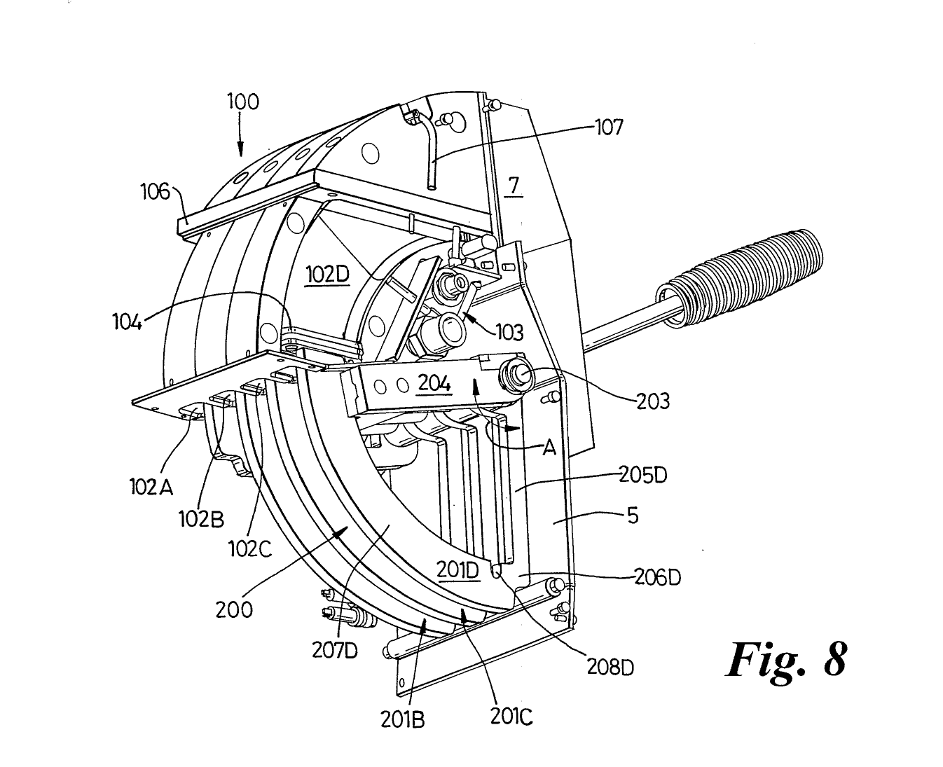

FIG. 8 is a part-internal view of the right-hand side of the dispensing apparatus of FIG. 1 showing a further plunger in its rest position;

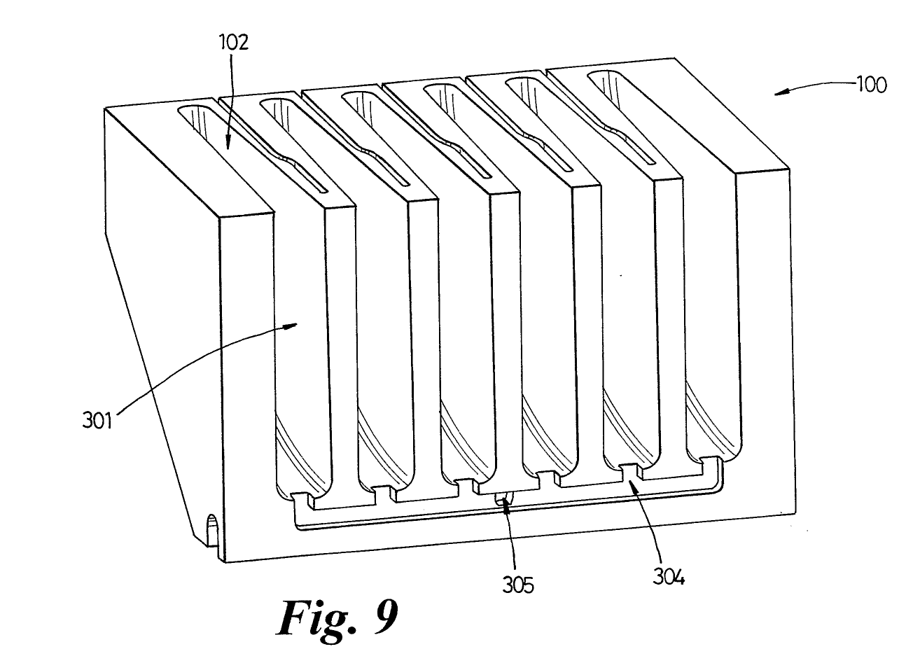

FIG. 9 shows the freezing apparatus of a second embodiment of the present invention;

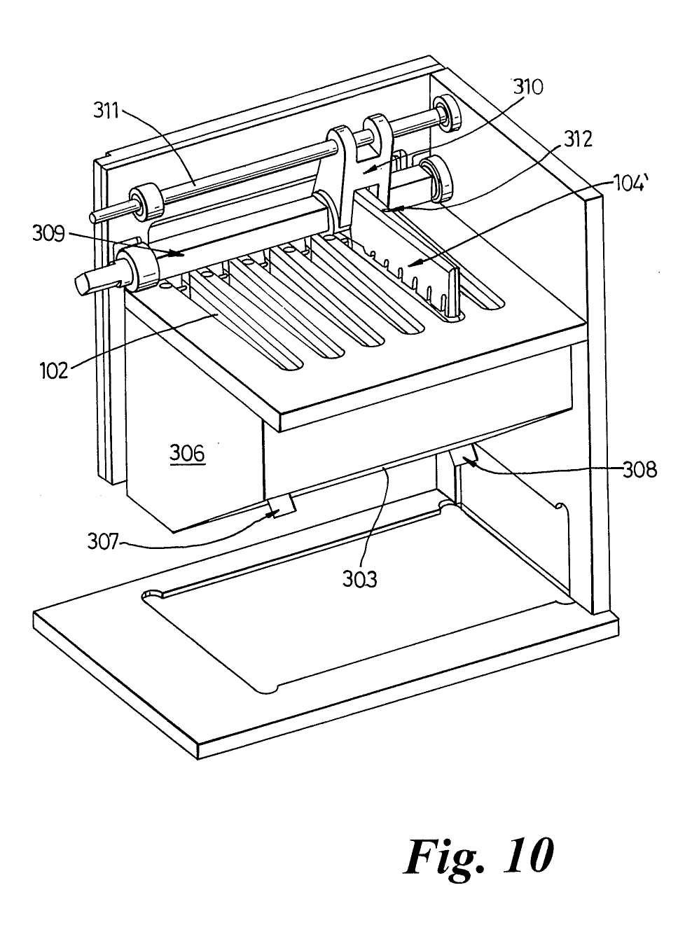

FIG. 10 shows the freezing apparatus and dispensing apparatus of the second embodiment of the present invention; and

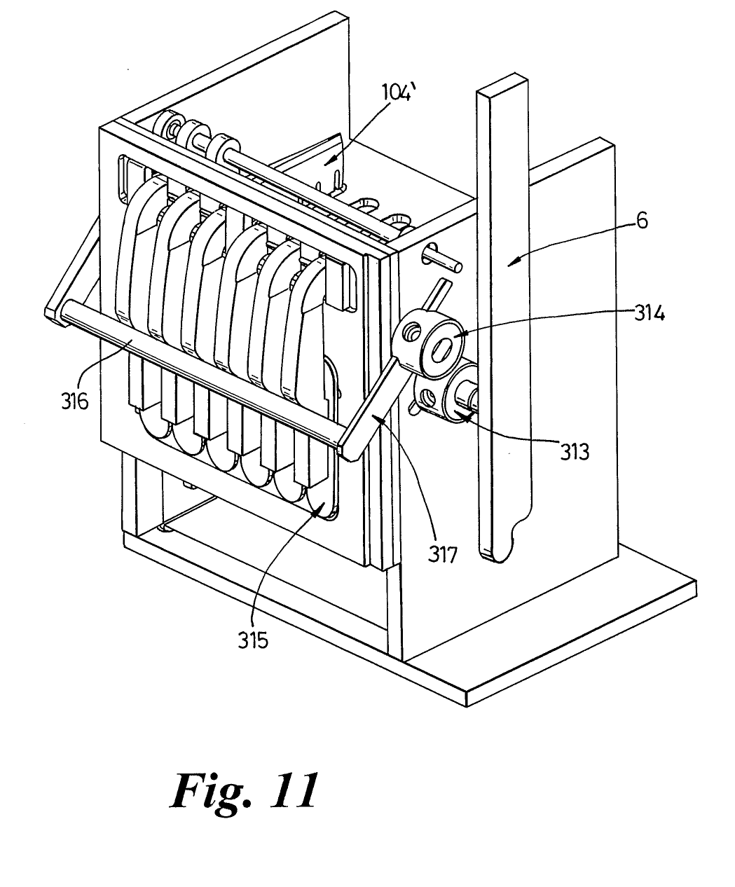

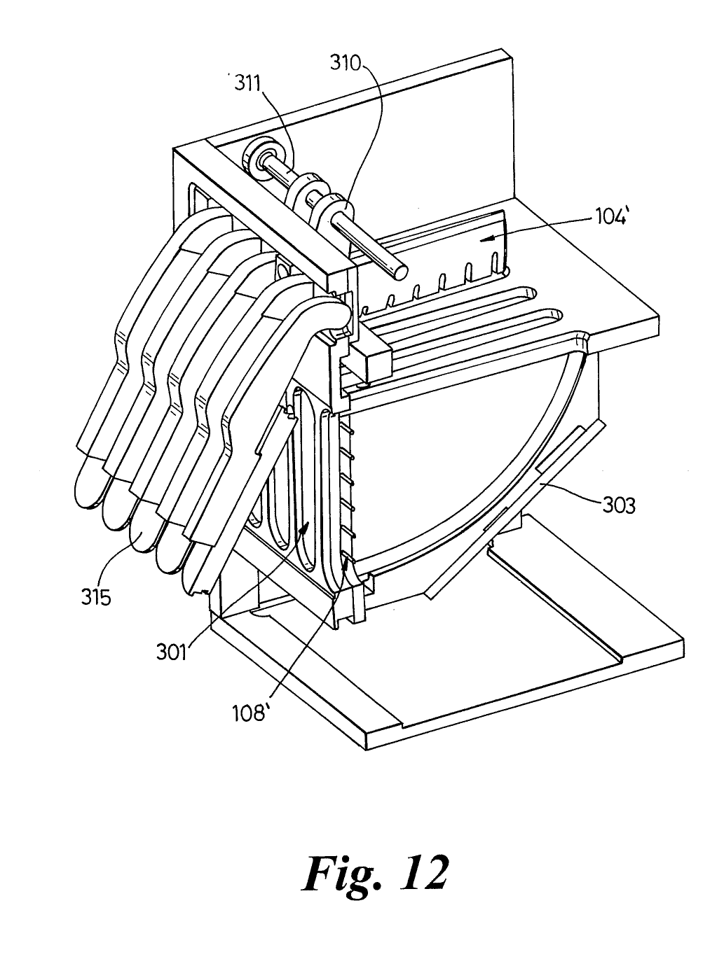

FIGS. 11 and 12 show part-internal views of the second embodiment of the present invention.

Referring to all of the FIGS. 1 to 8 but, in particular, to FIGS. 1 and 2, a dispensing font (dispensing apparatus) of the present invention is indicated generally by reference 1. The dispensing font 1 is provided with a clamping device 2, for clamping the dispensing font 1 to a bar top (not shown), in a similar manner to other dispensing fonts provided in bars and the like. The dispensing font 1—when viewed from the front by a notional customer at the bar—is provided with a right-hand-side casing 3, a left-hand-side casing 4 and a rear casing 5. Mounted upon and through the left-hand-side casing is a movable handle 6 for actuating the dispensing font 1. The handle 6 is the external member of dispensing means 200, which shall be elaborated upon further below. The rear casing 5 is further provided with a dispensing chute 7, through which frozen beverage may be dispensed. Beverage freezing apparatus, generally indicated by reference 100, are provided at an upper frontal region of the dispensing font 1. At a lower frontal region of the dispensing font 1 is provided a liquid collector 8, in the form of a drip tray 8. The drip tray 8 is emptied by pulling it out of the front of the apparatus. The tray may include one or two drain pipes (not shown) along its rear edge to allow excess liquid from the drip tray 8 to pass to a further collector.

Both the left-hand- and right-hand-side casings 4, 3 are aesthetic casing elements provided on top of load-bearing plates 4A, 3A, respectively. The load-bearing plates 4A, 3A provide substantial support to the dispensing font 1 using various cross-members, some of which are indicated by reference 9. Further, the load-bearing plates 4A, 3A are firmly secured to the clamping device 2, so as to provide a stable structure when the dispensing font 1 is clamped to a bar top (not shown).

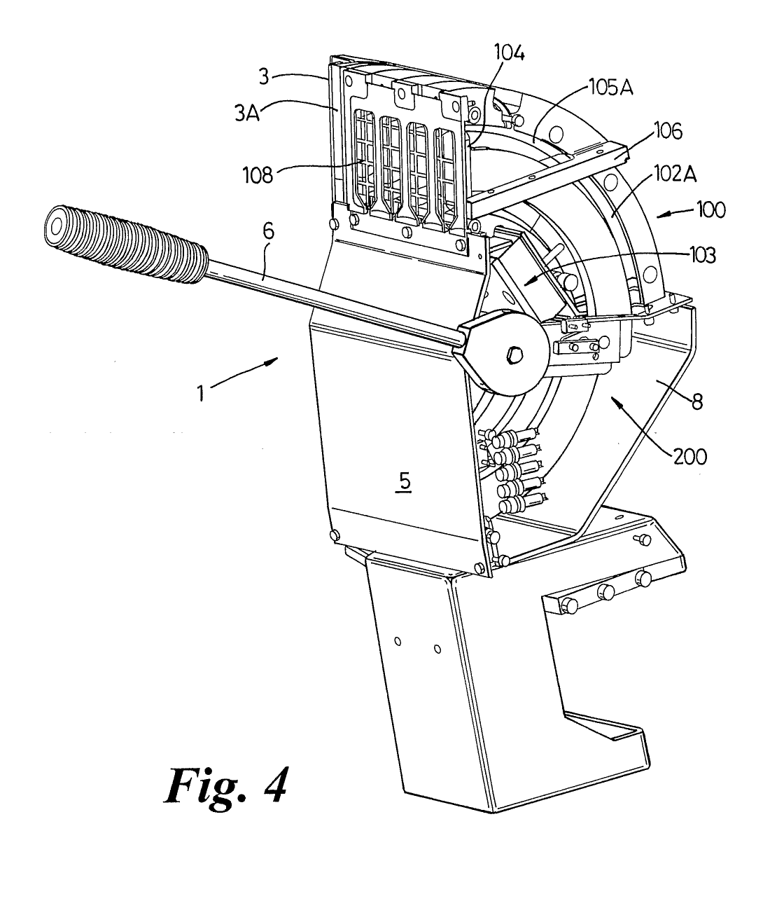

As shown in FIGS. 3 and 4, in particular, the beverage freezing apparatus 100 comprises four cooling chambers having lower portions 102A, 102B, 102C, 102D and upper portions 105A, 105B, 105C and 105D in a block of laminates. More or fewer cooling chambers may be provided if required. The block of laminates is bounded on left and right sides by insulation 101, insulating the cooling chambers from the load bearing plates 4A, 3A. Each of the cooling chambers is made of aluminium—although any material which is a good conductor of heat will do—and is coated in a food grade friction-reducing layer, such as PTFE (Teflon™), to aid dispensing of the frozen beverage from the cooling chamber. The lower portions of the four chambers 102A, 102B, 102C, 102D are provided by five laminates 110, 120, 130, 140, 150. The far left and right laminates 110, 150 are in contact with the insulation 101 on outermost sides and only form an outer edge of the lower portion of one chamber 102A, 102D respectively, that being formed on the inner side of the laminate. The three middle laminates 120, 130, 140 form the outer edges of the lower portions of two cooling chambers on left and right sides. As such, combining the five laminates in a block provides the lower portions of the four cooling chambers 102A, 102B, 102C, 102D. The aluminium laminates are machined in the desired shape but may be cast individually or as a single unit. The preferred shape of the bore of the cooling chambers is substantially arcuate but with a substantially rectangular cross-section. In preferred embodiments, the cross-sectional areas of the bores of the cooling chambers 102A, 102B, 102C, 102D are smaller at the bottom of the cooling chambers—where plungers 104 are located at rest—than at the top of the cooling chambers 102A, 102B, 102C, 102D to facilitate egress of frozen product from the chambers. Further, the substantially rectangularly-shaped cross-section of the bores is provided with rounded edges. This facilitates sealing of the plungers in the bores. The lower portions of the cooling chambers 102A, 102B, 102C, 102D are cooled by a Peltier element linked to a heat exchanger, indicated generally by reference 103, by direct contact of a part of each cooling chamber 102A, 102B, 102C, 102D with the cooling plate (not shown) of the Peltier element. The heat exchanger 103 is water-cooled using cooled water running through the main bar python cooling system. Each cooling chamber is provided with a correspondingly-shaped plunger 104 (movable base) which, in its rest position, provides a beverage-tight seal at the bottom of the cooling chamber. Each plunger is provided with a correspondingly-shaped o-ring seal to aid provision of the beverage-tight seal. Each cooling chamber has an upper portion 105A, 105B, 105C, 105D in a block of laminates, through which the frozen beverage will be guided when dispensed. Again, the block could be a single unit. The upper portions are also provided by five laminates 110A, 120A, 130A, 140A, 150A—in a similar manner to the laminates 110, 120, 130, 140, 150—and their arrangement in the block shall, therefore, not be described in further detail. As before, the laminates 110A, 120A, 130A, 140A, 150A are preferably made of aluminium and coated in PTFE (Teflon™). Alternatively, the block of cooling chambers may be a single polymer component. An insulator 106 is positioned between the lower portion laminates 110, 120, 130, 140, 150 and the upper portion laminates 110A, 120A, 130A, 140A, 150A. The insulator 106 is provided with holes which correspond to the position and shape of the lower and upper portions of the cooling chambers and provide an insulating link between the respective portions. As such, an arcuate bore of rectangular cross-section is provided through each of the lower portions of the cooling chambers 102A, 102B, 102C, 102D, the insulator 106 and each of the respective upper portions of the cooling chambers 102A, 105B, 105C, 105D, such that, the piston 104 can move freely through the bore. It will also be understood that, in a preferred embodiment, each arcuate bore has a smaller cross-sectional area at the bottom of each cooling chamber (in the region of the plunger 104 at rest) than at the end of each upper portion remote from the cooling chamber.

The cross-section increases in both directions of the rectangular section so that all four walls move away from the plunger as it is moved upwards.

A feed pipe 107 is provided for each cooling chamber in the upper portions 105A, 105B, 105C, 105D. As such, the feed pipes 107 are fed between laminates 110A, 120A, 130A, 140A, 150A of the upper portions in grooves and allow a portion of beverage to be caused to flow into the upper portion 105A, 105B, 105C, 105D of each cooling chamber, and fall into the cooling chamber lower portions 102A, 102B, 102C, 102D, where it is held in the cooling chamber from escape by the plunger 104. A processor module (not shown), for example a computer, controls operation of the feed pipes 107. In particular, the processor module controls the amount of beverage fed through each feed pipe 107 and the timing of beverage feed using, for example, standard pumps, valves and flowmeters (not shown).

Adjacent to the end of the arcuate bore formed through the upper portions 105A, 105B, 105C, 105D remote from the cooling chambers lower portions 102A, 102B, 102C, 102D is provided a mesh 108 through which frozen beverage will be forced, so as to produce reduced-size frozen beverage particles. Alternatively, the mesh 108 may be a grill, a grate or cutting elements. The dispensing chute 7 is positioned on the rear casing 5 to collect frozen beverage passed through the mesh 108 and channel it into a receptacle.

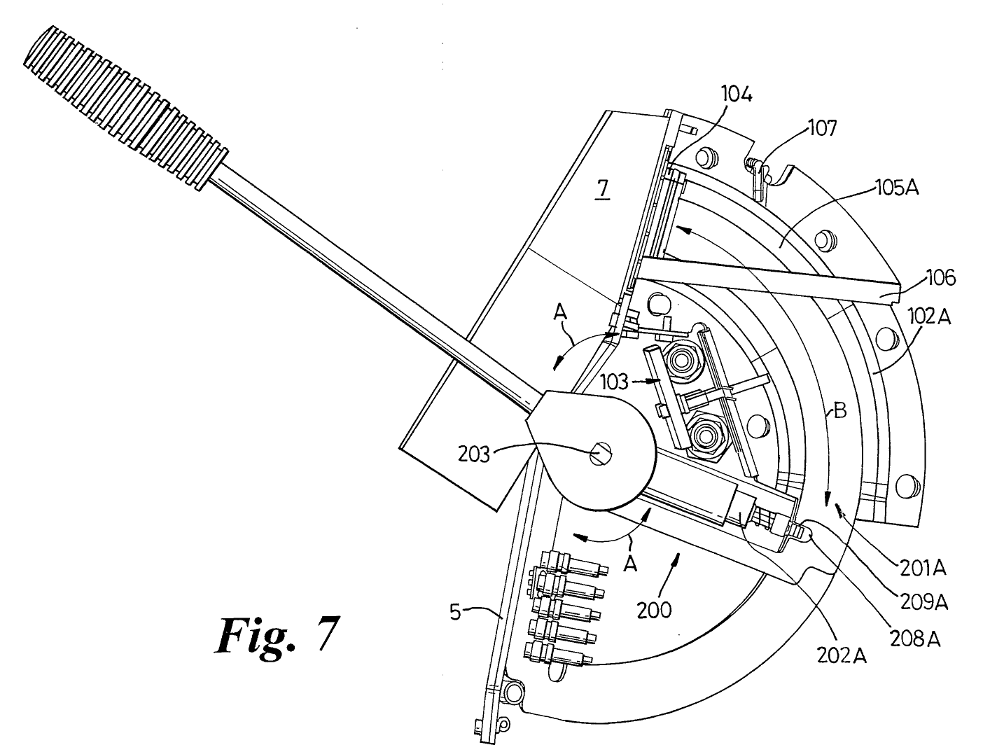

FIGS. 4 to 8 show, in particular, the dispensing means 200 which is provided with the handle 6, a plunger rod 201A, 201B, 201C, 201D for each plunger and a selector device 202A, 202B, 202C, 202D, in the form of a solenoid, for selectively connecting the handle 6 to one of the plunger rods 201A, 201B, 201C, 201D. The handle 6 is fixedly-mounted on a frame 204 which holds the solenoids 202A, 202B, 202C, 202D. The solenoids 202A, 202B, 202C, 202D are also controlled by the processor module such that, when one of the cooling chamber lower portions 102A, 102B, 102C, 102D contains frozen beverage, that chamber is selected for dispensing. However, if no solenoid 202A, 202B, 202C, 202D is selected, the handle 6 and frame 204 move without dispensing frozen beverage. Thus, when the handle is pulled (rotated about the axis of the cam 203), the handle 6 and frame 204—containing the solenoids—can rotate through an angle of nearly 90°. As shown in FIG. 7, in particular, movement of the handle 6 and frame 204 are shown by Arrows A. In a rest position, the handle 6 extends substantially vertically upwards of the dispensing font 1 and shaft 203, and the frame 204 extends substantially vertically downwards of the shaft 203 within the dispensing font 1. When the handle is pulled, it can rotate in a direction towards a user, as shown by Arrow A, and can cause a corresponding movement of the frame 204 within the font 1, also shown by Arrow A, to arrive in the dispensed position shown in the Figures. Releasing the handle 6 allows a return movement of the handle 6 and frame 204 to their respective rest positions. Each plunger rod 201A, 201B, 201C, 201D is independently rotatable around the axis of the shaft 203 at an end of the plunger rod and is provided with a straight and an arcuate section of the rod. FIG. 8, in particular, shows that—using dispensing rod 201D as an example of all four dispensing rods—the straight section 205D is rotatable about the axis of the shaft 203 at one end. The other end forms a substantially 90° bend 206D from which stems the arcuate section 207D. The arcuate section 207D is provided with a curvature similar to the curvature of the cooling chambers 102A, 102B, 102C, 102D. The distal end of the arcuate section 207D, remote from the bend 206, is connected to the plunger 104. At or around the region of the bend 206D of the dispensing rod 201D is provided a notch 208D into which a movable armature 209D of the solenoid 202D can move, when the cooling chamber 102D is selected for dispensing. The dispensing rod 201D is rotatable about the axis of the shaft 203, in response to a movement of the handle 6, and, which movement, causes the plunger 104 to move through the bore provided by the cooling chamber 102D, the insulator 106 and the upper portion 105D, from its rest position to its dispensed position, as shown approximately by Arrow B. Each other plunger rod 201A, 201B, 201C is arranged identically to dispensing rod 201D and can move in a corresponding manner. Further, FIG. 7 shows the dispensing rod 201A in its dispensed position after a corresponding movement has occurred. Again, its movement is shown approximately by Arrow B. FIG. 7 also shows that selection of cooling chamber lower section 102A for dispensing frozen beverage has occurred by the movable armature 209A of the solenoid 202A being located in the notch 208A of the dispensing rod 201A. From the figure it can be seen that a previous movement of the handle 6 and the frame 24 has occurred. As a consequence, a corresponding movement of the dispensing rod 201A through the cooling chamber lower portion 102A has occurred—as is shown approximately by Arrow B—which movement of the dispensing rod 201A would have pushed the plunger 104 through the cooling chamber 102A, the insulator 106 and the upper portion 105A, to dispense frozen beverage from the dispensing apparatus through the mesh 8.

In use, beverage, in particular cider or beer, is fed from a storage area, such as a keg (not shown) located in the cellar of a bar, to the dispensing font 1 through a pipe. One or more stages of cooling may occur before the cider or beer reaches the dispensing font 1, for example, the cellar may be cooled and/or the beverage line may pass through a python. In addition, there may be a heat exchanger, such as a flash cooler, located adjacent the dispensing font 1.

Just prior to or within the dispensing font 1, the beverage line (not shown) is divided to provide a liquid-beverage portion and a portion of beverage for freezing. The liquid-beverage portion may be dispensed into a receptacle through dispensing means, such as a tap, of the dispensing font 1 or, indeed, through a tap of a separate dispensing font (not shown). The portion of beverage for freezing may be further chilled and is then sub-divided into four beverage streams, provided by the feed pipes 107. Each feed pipe 107 supplies a cooling chamber lower portion 102A, 102B, 102C, 102D with beverage according to the predetermined settings provided for by the processor module controlling the pumps and valves—and therefore the timing and amount of beverage fed into the cooling chambers. An amount of the portion of beverage for freezing is fed into the cooling chamber lower portion 102A, 102B, 102C, 102D where it is frozen by contact of the beverage with the sidewalls of the cooling chamber—the side walls being at a temperature of around −5° to −20°, preferably around −7 to −8° C., provided by the Peltier element 103. The exact temperature depends on the beverage being dispensed but must be lower than the freezing point of the beverage. Freezing of the beverage may take from around 10 seconds to 30 minutes each time. Once the beverage is frozen, and the user wishes to dispense a portion, the frozen-beverage portion is dispensed from the cooling chamber by operation of the handle 6. One of the solenoids 202A, 202B, 202C, 202D is caused to interact with one of the plunger rods 201A, 201B, 201C, 201D, so that operation of the handle 6 moves one of the plunger rods 201A, 201B, 201C, 201D. The plunger rod 201A, 201B, 201C, 201D moves the plunger 104 through the cooling chamber lower portions 102A, 102B, 102C, 102D forcing the frozen-beverage portion upwards, through the upper portion 105A, 105B, 105C, 105D and, on leaving the upper portion, through the mesh 108, where it is caught by the dispensing chute 7 and channelled into the previously dispensed liquid-beverage portion, residing in the glass.

Alternatively, the frozen-beverage portion may be dispensed prior to or simultaneously with the dispensing of the liquid beverage portion.

Advantageously, operation of the dispensing font 1 may be automated providing dispensation of one or both beverage portions at the touch of one or more buttons.

A second embodiment of the present invention is shown in FIGS. 9 to 12.

FIG. 9 shows a freezing block 100′ in which six cooling chambers 102 are formed each having an opening 301 from which a frozen-beverage portion can be dispensed. The block is formed of cast, molded or machined conducting metal such as aluminium and may be coated with PTFE.

Each chamber 102 is arcuate with the radius of curvature increasing gradually towards the opening. The cross-section through the chamber in a radial direction is an isosceles trapezoid with two rounded edges. The cross-sectional area through the chamber in a radial direction increases towards the opening. The rounded corners and the increase in cross-sectional area towards the opening facilitate dispensing of frozen-beverage from the chamber.

The cooling means is a series of channels in the freezing block through which a coolant such as water/glycol can be circulated. The channels are formed inside the walls between the chambers. A coolant (supplied by an external chiller—not shown) enters the channels through an inlet 308 and leaves through outlet 307 (see FIG. 10) after circulating through the channels which surround all sides of the cooling chambers 102 to ensure efficient and uniform freezing of beverage in the cooling chambers.

The freezing block 100′ includes a conduit 304 leading to a drain channel 305. As beverage is introduced into the cooling chambers 102, it flows from the base of the chambers into the conduit 304 where it freezes to form a frozen plug of beverage. This frozen plug remains in the freezing block during dispense of the frozen-beverage portion(s) so that during subsequent introduction of further beverage for freezing into a chamber from which a frozen-beverage portion has been previously dispensed, the frozen lug acts to prevent drainage of the beverage from the freezing block.

When cleaning of the freezer block becomes necessary, the frozen plug of beverage can be thawed by cessation of the coolant flow to allow water/cleaning product to flow through the chambers 102, the conduit 304 and to exit the freezer block through the drain channel 305.

As can be seen in FIG. 10, the freezer block is encased within insulation 306 minimise heat gain from the surroundings and is closed with a flat plate 303 to seal the coolant channels. A coolant inlet 307 and outlet 308 are provided in the flat plate 303.

FIG. 10 also shows the dispensing/ejection means for forcing frozen-beverage portion from the cooling chambers. The dispensing/ejection means is a single finger plunger 104′ mounted on a square shaft 309. The plunger is moveable along the square shaft by an indexer 310 mounted on a lead screw 311. It is moveable into alignment with any one of the cooling chambers 102 (e.g. using a positional motor controlled by microcontroller) and, when at rest, i.e. when no frozen-beverage portion dispense is occurring, the plunger 104′ remains substantially external to the cooling chambers.

The plunger 104′ also includes a beverage conduit 312 which is connected to a feed pipe (not shown). The feed pipe supplies beverage for freezing to the cooling chambers via the plunger beverage conduit 312. A processor module (not shown), for example a computer, controls operation of the feed pipe. In particular, the processor module controls the amount of beverage fed through the feed pipe and the timing of beverage feed using, for example, standard pumps, valves and flowmeters (not shown). In an alternative embodiment (not shown) the beverage conduit to which the feed pipe connects is provided in the indexer 310 rather than the plunger. This arrangement may be advantageous in that the beverage feed can be angled (e.g. at 30 degrees) from the vertical so that the beverage feed hits the side of the chamber wall. This should reduce frothing of the beverage.

FIGS. 11 and 12 show how the plunger is actuated. A gear mechanism is provided with a first gear wheel 313 connected to a handle 6 and a second gear wheel 314 connected to the square shaft 309 (not shown). As the handle 6 is pulled towards the user (the chamber openings will be proximal the user), the gear mechanism reverses the motion of the first gear wheel 313 so that the square shaft 309 pivots about the axis of the second gear wheel 314 causing the plunger 104′ to sweep through the selected chamber 102 to push the frozen-beverage portion through the chamber opening 301.

In alternative embodiments the mechanism to reverse the action of the handle to cause the plunger to sweep through a cooling chamber may include a lever system and/or a belt system.

Each chamber opening 301 is sealed by sealing means comprising a door 315. In the rest position, i.e. when no frozen-beverage dispense is occurring, each of the doors 315 rests against its respective opening 301. Each door is pivotable such that, during dispense, the door of the selected chamber from which the frozen-beverage portion is to be dispensed, pivots away from the chamber opening.

Biasing means are provided to bias the doors against their respective opening in the rest position. The biasing means comprise a contact bar 316 which abuts the doors 315 and a mounting portion 317 which is mounted upon the second gear wheel 314.

When frozen beverage dispense occurs, rotation of the second gear wheel 314 (as a result of the rotation of the first gear wheel 313 by the handle actuation) causes the contact bar 316 of the biasing means to pivot away from the doors 315. The pressure of the frozen-beverage portion against the door 315 (under the action of the plunger) in the absence of the biasing means forces the door open as can be seen in FIG. 12. Although FIG. 12 shows all doors open, this will not occur; only the door to the chamber through which the plunger moves will open to allow the frozen-beverage portion to be dispensed from the chamber.

In alternative embodiments, a cam is provided on the plunger to partially open the door during dispense.

As the handle 6 is returned to its rest position, the return rotation of the second gear wheel 314 will raise the plunger 104′ back to its rest position and will return the biasing means to its rest position with the contact bar 316 of the biasing means closing the door to the chamber from which beverage has been dispensed. As the plunger 104′ is returned to its rest position, beverage will be introduced into the now empty cooling chamber through the feed pipe and the beverage conduit.

FIG. 12 also shows the means for reducing the particle size of the frozen-beverage portion. The means comprise grating bars 108′ across the openings 301 such that the plunger 104′ forces the frozen-beverage portion through the bars.

As the frozen-beverage portion is forced from the chamber through the grate, it is channelled into a receptacle such as a drinking glass through a chute (not shown).

In use, beverage, in particular cider or beer, is fed from a storage area, such as a keg (not shown) located in the cellar of a bar, to the dispensing apparatus through a pipe. One or more stages of cooling may occur before the cider or beer reaches the dispensing apparatus, for example, the cellar may be cooled and/or the beverage line may pass through a python. In addition, there may be a heat exchanger, such as a flash cooler, located adjacent the dispensing apparatus.

Just prior to or within the dispensing apparatus, the beverage line (not shown) is divided to provide a liquid-beverage portion and a portion of beverage for freezing. The liquid-beverage portion may be dispensed into a receptacle through dispensing means, such as a tap, of the dispensing apparatus or through a tap of a separate dispensing font (not shown). The portion of beverage for freezing may be further chilled and is then supplied to the cooling chambers 102 by the feed pipe via the beverage conduit 312 in the plunger 104′. The feed pipe supplies a cooling chamber 102 with beverage according to the predetermined settings provided for by the processor module controlling the pumps, valves—and therefore the timing and amount of beverage fed into the cooling chambers. An amount of the portion of beverage for freezing is fed into the cooling chamber(s) 102 where it is frozen by contact of the beverage with the sidewalls of the cooling chamber—the side walls being at a temperature of around −8° C. as a result of the glycol coolant flow in the channels. The exact temperature depends on the beverage being dispensed but must be lower than the freezing point of the beverage. Freezing of the beverage may take from around 10 seconds to 30 minutes each time but preferably takes around 8-10 minutes.

Once the beverage is frozen, and the user wishes to dispense a portion, the frozen-beverage portion is dispensed from the cooling chamber 102 by operation of the handle 6. As discussed previously, the actuation of the handle causes the contact bar 316 of the biasing means to pivot away from the doors 315 and the plunger 104′ to sweep through the selected chamber 102 to push the frozen-beverage portion through the grating 108′, the pressure of the frozen-beverage portion forcing the door open such that the frozen-beverage portion can exit the chamber 102 through the opening where it is caught by the dispensing chute and channelled into the previously dispensed liquid-beverage portion, residing in the glass/receptacle.

Alternatively, the frozen-beverage portion may be dispensed prior to or simultaneously with the dispensing of the liquid beverage portion.

In preferred embodiments, in the absence of dispense occurring from the or each chamber, the glycol flow can be stopped so that the walls of the cooling chamber increase slightly in temperature e.g. to −4° C. to avoid the frozen beverage portion from becoming too solid for dispensing.

Advantageously, operation of the dispensing apparatus may be automated providing dispensation of one or both beverage portions at the touch of one or more buttons.

While the apparatus has been described as particularly useful for dispensing frozen cider or beer into cider or beer, it may also be used for other alcoholic beverages, for example, beer including lager, ale and stout, spirits, and alcohol/non-alcohol mixed beverages.

1. Apparatus for dispensing a frozen-beverage portion, the apparatus comprising:
means for freezing a portion of beverage, so as to provide a frozen-beverage portion; and
means for dispensing the frozen-beverage portion into a receptacle.

2. Apparatus according to claim 1 further comprising means for dispensing into the receptacle a liquid-beverage portion.

3. Apparatus according to claim 2, wherein the means for dispensing the liquid-beverage portion into the receptacle is a tap mounted on a bar-top dispense font.

4. Apparatus according to claim 1, wherein the means for freezing a portion of beverage is one or more cooling chambers cooled by a cooling means.

5. Apparatus according to claim 4 wherein the means for freezing a portion of beverage is a plurality of cooling chambers.

6. Apparatus according to claim 5 wherein each chamber is dimensioned for freezing a portion of beverage to form a frozen-beverage portion sufficient for only a single dispense.

7. Apparatus according to claim 4, wherein the cooling chamber has an opening through which the frozen-beverage portion can be ejected.

8. Apparatus according to claim 7 wherein the opening is provided with a sealing member to seal the opening.

9. Apparatus according to claim 8 further comprising biasing means to bias the sealing member towards the opening.

10. Apparatus according to claim 4 wherein the cooling chamber is arcuate.

11. Apparatus according to claim 10 wherein the cooling chamber has an opening through which the frozen-beverage portion can be ejected and the radius of curvature of the chamber increases towards the opening.

12. Apparatus according to claim 10 wherein the cross-section through the chamber in a radial direction is a circle, a rectangle or an isosceles trapezoid.

13. Apparatus according to claim 12 wherein the cross-section through the chamber in a radial direction increases towards the opening.

14. Apparatus according to claim 4, wherein the inside of the chamber is coated in a friction-reducing layer.

15. Apparatus according to claim 4 wherein the cooling means is a channel system for carrying coolant.

16. Apparatus according to claim 4 wherein the means for dispensing the frozen-beverage portion is at least one element for mechanically forcing the frozen beverage from the cooling chambers.

17. Apparatus according to claim 16 wherein each cooling chamber is provided with a dedicated element.

18. Apparatus according to claim 17 wherein a single element is provided moveable between a plurality of cooling chambers.

19. Apparatus according to claim 16 wherein each element forms a moveable base of its respective chamber.

20. Apparatus according to claim 18 wherein the element is a pivotable plunger.

21. Apparatus according to claim 1, wherein the means for dispensing the frozen-beverage portion further comprises means for providing reduced-size particles of the frozen-beverage portion.

22. Apparatus according to claim 21 wherein the means for providing reduced-size particles is a grill, grate or mesh.

23. Apparatus according to claim 2, wherein the means for freezing the portion of beverage and the means for dispensing the frozen-beverage portion are housed in a dispense font.

24. Apparatus according to claim 23, wherein the dispense font further comprises the means dispensing the liquid-beverage portion.

25. Apparatus according to claim 2, wherein the means for dispensing the liquid- and frozen-beverage portions are located proximally, so that both beverage portions can be dispensed without needing to move the receptacle.

26. (canceled)

27. A method for dispensing a frozen-beverage portion, the method comprising:
providing one or more cooling chambers cooled by a cooling means;
supplying at least one of the cooling chambers with a portion of beverage;
freezing the portion of beverage to provide at least one frozen-beverage portion; and
ejecting one frozen beverage portion from its cooling chamber.

28. Method according to claim 27 comprising providing a plurality of cooling chambers.

29. Method according to claim 28 wherein each chamber is dimensioned for freezing a portion of beverage to form a frozen-beverage portion sufficient for only a single dispense.

30. Method according claim 27 comprising providing the or each cooling chamber with an opening through which the frozen-beverage portion can be ejected.

31. Method according to claim 30 comprising providing the or each opening with a sealing member to seal the opening.

32. Method according to claim 31 further comprising providing biasing means to bias the sealing member towards the opening.

33. Method according to claim 27 comprising providing one or more arcuate cooling chambers.

34. Method according to claim 33 comprising providing the or each cooling chamber with an opening through which the frozen-beverage portion can be ejected and comprising providing one or more cooling chambers with a radius of curvature of the chamber increases towards the opening.

35. Method according to claim 33 comprising providing one or more cooling chambers wherein the cross-section through the chamber (s) in a radial direction is a circle, a rectangle or an isosceles trapezoid.

36. Method according to claim 35 comprising providing one or more cooling chambers in which the cross-section through the chamber in a radial direction increases towards the opening.

37. Method according to any one of claim 27 comprising providing one or more cooling chambers coated on its/their inside with a friction-reducing layer.

38. Method according to claim 27 comprising providing a channel system for carrying coolant as a cooling means.

39. Method according to claim 27 comprising ejecting the frozen beverage portion using at least one element for forcing the frozen beverage from the one or more cooling chambers.

40. Method according to claim 39 comprising ejecting the frozen-beverage portion using a dedicated element.

41. Method according to claim 40 comprising ejecting the frozen-beverage portion using a single element moveable between a plurality of cooling chambers.

42. Method according to claim 40 comprising ejecting the frozen-beverage portion using a dedicated element which forms a moveable base of its respective chamber.

43. Method according to claim 41 comprising ejecting the frozen-beverage portion using a pivotable plunger as the element.

44. Method according to claim 27 comprising reducing the particle size of the frozen-beverage portion.

45. Method according to claim 44 comprising reducing the particle size using a grill, grate or mesh.

46. Method according to claim 27 comprising providing means for dispensing a liquid-beverage portion.

47. Method according to claim 46 comprising housing the one or more cooling chambers and the means for dispensing a liquid-beverage portion in a dispense font.

48. (canceled)

49. A beverage dispensing system comprising:
one or more fonts for dispensing a liquid-beverage portion and a frozen-beverage portion into a receptacle; and
a supply of liquid beverage to the one or more fonts, the supply of liquid beverage being separatable to provide a liquid-beverage portion and a portion of beverage for freezing to provide a frozen-beverage portion;
wherein, the liquid- and frozen-beverage portions are dispensable into the receptacle.
